(19) United States
(12) Patent Application Publication
(10) Pub. No.: US 2026/0171716 A1
(43) Pub. Date: Jun. 18, 2026

(54) Calrod Electrical Connector Assembly

(71) Applicant: TE Connectivity Solutions GmbH, Schaffhausen (CH)

(72) Inventors: Brian Keith WEAVER, Middletown, PA (US); Tyler BLAIR, Middletown, PA (US); David T HUMPHREY, Middletown, PA (US)

(73) Assignee: TE Connectivity Solutions GmbH, Schaffhausen (CH)

(21) Appl. No.: 18/983,518

(22) Filed: Dec. 17, 2024

(51) Int. Cl. H01R 13/627; H01R 13/52; H01R 13/631; H05B 3/42

(52) U.S. Cl. CPC H01R 13/6271; H01R 13/5205; H01R 13/631; H05B 3/42

(57) ABSTRACT

An electrical connector having a housing with a mating end and a terminal receiving end. Housing side walls and housing releasable locking latches extend between the mating end and the terminal receiving end. A center terminal receiving member extends from the terminal receiving end to the mating end. A terminal is positioned in the center terminal receiving member. The terminal has a mating section and a wire receiving section. The connector can be mated at different orientations relative to a mating electrical connector.

### FIELD OF THE INVENTION

The invention relates to a calrod electrical connector assembly. In particular the invention related to a connector assembly with alignment features which allow the connector assembly to mate at different orientations.

### BACKGROUND OF THE INVENTION

Calrod connector assemblies are used to connect to electric tubular heating elements used to produce radiant heat in an application. Calrod heating elements are used in many applications such as kitchen appliances, flange heaters, screw plug heaters and over the side heaters. Calrod connector assemblies are often in the form of quick disconnect receptacle connectors in which a tab is inserted. The tab is generally welded onto the heating element cold pin with heat shrink provided around the cold pin and partially onto the weld tab.

It would be beneficial to provide a calrod connection assembly which has housing with completely shrouds the cold pin and the connection area, allowing the electrical connection is made directly to the heating element cold pin and eliminates the need for the heat shrink tubing.

### SUMMARY OF THE INVENTION

The following provides a summary of certain illustrative embodiments of the present invention. This summary is not an extensive overview and is not intended to identify key or critical aspects or elements of the present invention or to delineate its scope.

An object is to provide a calrod connection assembly which has housing with completely shrouds the cold pin and the connection area, allowing the electrical connection is made directly to the heating element cold pin and eliminates the need for the heat shrink tubing.

An embodiment is directed an electrical connector having a housing with a mating end and a terminal receiving end. Housing side walls and housing releasable locking latches extend between the mating end and the terminal receiving end. A center terminal receiving member extends from the terminal receiving end to the mating end. A terminal is positioned in the center terminal receiving member. The terminal has a mating section and a wire receiving section. The connector can be mated at different orientations relative to a mating electrical connector.

An embodiment is directed an electrical connector assembly having a first electrical connector and a second electrical connector. The first electrical connector includes a first housing with a first mating end and a first terminal receiving end. First housing side walls and first housing releasable locking latches extend between the first mating end and the first terminal receiving end. A first center terminal receiving member extends from the first terminal receiving end to the first mating end. A first terminal is positioned in the first center terminal receiving member. The first terminal has a first mating section and a first wire receiving section. The second electrical connector includes a second housing with a second mating end and a second compression member receiving end. Second housing side walls extend between the second mating end and the second compression member receiving end. A second terminal receiving opening extends from the second mating end. A second terminal is positioned in the second terminal receiving opening. A compression member is provided in the second terminal receiving opening proximate the second compression member receiving end. The first electrical connector can be mated at different orientations relative to the second electrical connector.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

FIG. 1 is a front perspective view of a first illustrative embodiment of an assembled receptacle connector assembly of the present invention.

FIG. 2 is a back perspective bottom view of the receptacle connector assembly of FIG. 1.

FIG. 3 is a back perspective bottom view of the receptacle connector assembly of FIG. 1 with the cover removed.

FIG. 4 a perspective view of an illustrative embodiment of a terminal of the receptacle connector assembly of FIG. 1.

FIG. 5 a perspective view of an illustrative embodiment of the cover of the receptacle connector assembly of FIG. 1.

FIG. 6 is a back perspective view of a first illustrative embodiment of an assembled plug connector assembly of the present invention.

FIG. 7 is a front perspective bottom view of the plug connector assembly of FIG. 6.

FIG. 8 is a perspective view of the plug connector assembly of FIG. 6 and the receptacle connector assembly of FIG. 1 prior to mating.

FIG. 9 is a perspective view of the plug connector assembly of FIG. 6 mated to the receptacle connector assembly of FIG. 1.

FIG. 10 is a cross sectional view taken along line 10-10 of FIG. 6.

FIG. 11 is a front perspective view of a second illustrative embodiment of an assembled receptacle connector assembly of the present invention.

FIG. 12 is a back perspective bottom view of the receptacle connector assembly of FIG. 11.

FIG. 13 is a front perspective view of a second illustrative embodiment of an assembled plug connector assembly of the present invention.

FIG. 14 is a perspective view of the plug connector assembly of FIG. 13 mated to the receptacle connector assembly of FIG. 11.

FIG. 15 is a cross sectional view taken along line 15-15 of FIG. 14.

The accompanying drawings, which are incorporated into and form a part of the specification, schematically illustrate one or more exemplary embodiments of the invention and, together with the general description given above and detailed description given below, serve to explain the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. In various applications, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

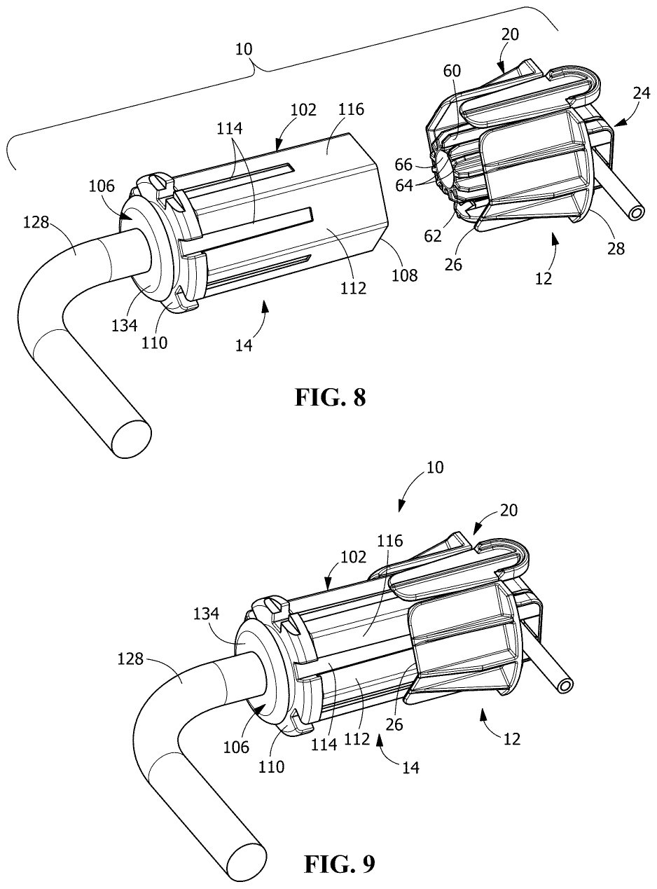

As shown in FIGS. 8, 9 and 10, the illustrative electrical connector assembly 10 includes an illustrative receptacle connector assembly 12 and an illustrative plug connector assembly 14. The receptacle connector assembly 12 may be mated to the plug connector assembly 14 in a number of various orientations, as will be more fully described.

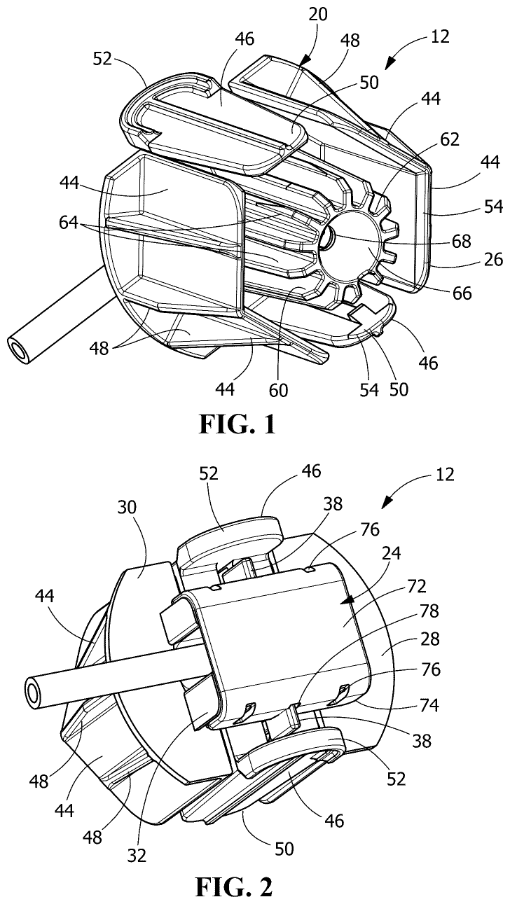

As shown in FIGS. 1 and 2, the illustrative receptacle connector assembly 12 includes a housing 20, an electrical terminal 22 and a cover 24. The housing 20 has a cold pin mating end 26 and an oppositely facing terminal receiving end 28.

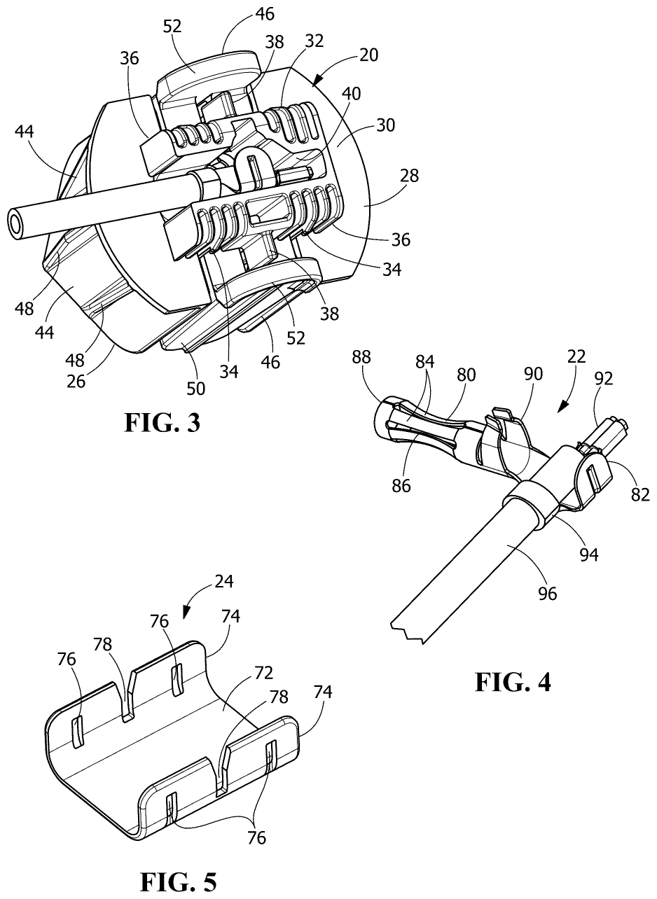

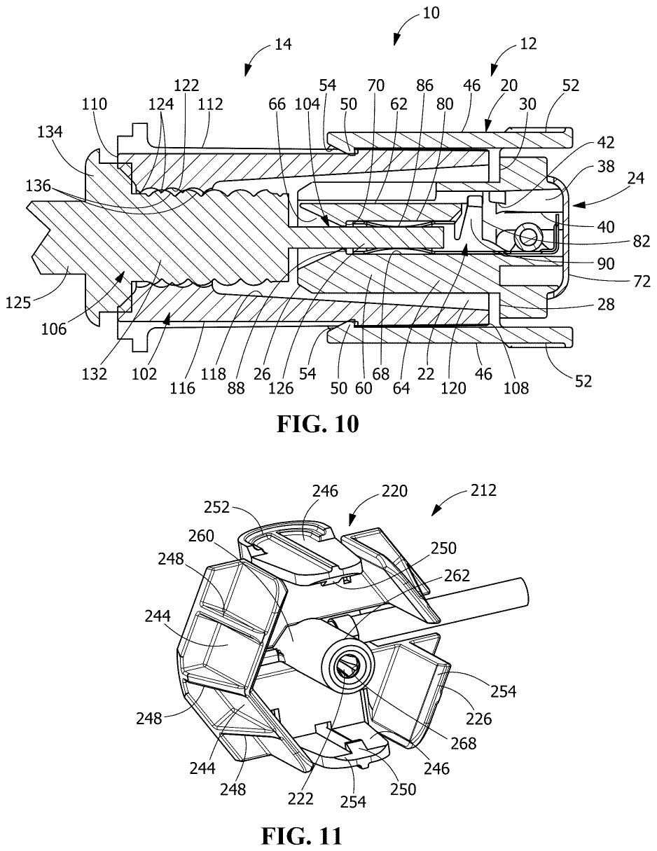

As shown in FIG. 3, the terminal receiving end 28 of the housing 20 has a generally flat surface 30 which acts an a large ergonomic push surface to facilitate the mating of the receptacle connector assembly 12 to the plug connector assembly 14. A cover mounting portion 32 extends from the flat surface 30 in a direction away from the cold pin mating end 26. The cover mounting portion 32 has latching projections 34 which extend from side surfaces 36. Latch limiting projections 38 also extend from side surfaces 36 of the cover mounting portion 32. A terminal receiving recess 40 is provided in the cover mounting portion 32 and extends from the flat surface 30 in a direction toward the cold pin mating end 26. A terminal mounting opening 42 (FIG. 10) is provided in the terminal receiving recess 40.

Side walls 44 extend between the cold pin mating end 26 and the terminal receiving end 28. Releasable locking latches 46 also extend between the cold pin mating end 26 and the terminal receiving end 28. In the embodiment shown four side walls 44 and two locking latches 46 are provided to form a hexagonal configuration. However, other numbers and configurations of side walls 44 and locking latches 48 may be used.

The side walls 44 have supporting ribs or projections 48. The ribs or projections 48 extend from the side walls 44 to the underside of the flat surface 30 of the terminal receiving end 28 of the housing 20. The ribs or projections 48 provide structural integrity to the side walls 44.

The releasable locking latches 46 have latching portions 50 which extends from the terminal receiving end 28 toward the cold pin mating end 26. The releasable locking latches 46 have release portions 52 which extend from the terminal receiving end 28 in a direction away from the cold pin mating end 26. The releasable locking latches 46 are pivotally attached to the terminal receiving end 28, such that as the release portions 52 are moved toward the side surface 36, the latching portions 50 are moved outward. The side walls 44 and the locking latches 46 have angled lead in surfaces 54 provided proximate the cold pin mating end 26, as viewed in FIG. 1.

A center terminal receiving member 60 extends from the terminal receiving end 28 to the cold pin mating end 26. In the illustrative embodiment shown, the terminal receiving member 60 has a circular cross section with a continuous side wall 62. Ribs or projections 64 extend outward from the side wall 62 toward the side walls 44 and the locking latches 46. The ribs or projections 64 are spaced periodically around the circumference of the side wall 62.

As shown in FIG. 10, a sloped lead in surface 66 is provided on the side wall 62 proximate the cold pin mating end 26. The terminal receiving member 60 has a terminal receiving opening 68 which extends from the lead in surface 66 to the terminal receiving end 28. The terminal receiving opening 68 is positioned in alignment with the terminal mounting opening 42. A terminal positioning shoulder 70 is provided at the ends of the terminal receiving opening 68 proximate the lead in surface 66.

As shown in FIGS. 2 and 5, the removable cover 24 has a flat surface 72 with side walls 74 extending therefrom. The side walls have first latching projection receiving slots 76 which cooperate with the latching projections 34 to secure the cover 24 to the housing 20, as shown in FIG. 2. The side walls have second latch limiting projection receiving slots 78 which allow the latch limiting projections 38 to extend through the cover 24 to the housing 20.

Referring to FIGS. 4 and 10, an illustrative embodiment of the terminal 22 is shown. The terminal 22 has a mating section 80 and a wire receiving section 82. In the illustrative embodiment shown, an longitudinal axis of the mating section 80 is positioned approximately at ninety degrees to a longitudinal axis of the wire receiving section 82.

The mating section 80 has a cylindrical configuration with multiple resilient contact beams 84 which have contact sections 86 which extend inward. A free end 88 of the mating section 80 is proximate to or abuts the terminal positioning shoulder 70 when the terminal 22 is positioned in the terminal receiving opening 68. A retention clip 90 is provided on the mating section. The retention clip 90 is positioned between the multiple resilient contact beams 84 and the wire receiving section 82. As shown in FIG. 10, the retention clip 90 helps to properly position and maintain the mating section 80 in the proper position in the terminal receiving opening 68.

Referring to FIG. 4, the wire receiving section 82 has a first securing section 92 and a second securing section 94. The first securing section 92 engages the conductive members of the wire 96 to electrically connect the wire 96 to the terminal 22. In the embodiment shown, the first securing section 92 is crimped to the conductive members of the wire 96, however, other methods of termination may be used. The second securing section 94 engages the outer cover of the wire 96 to provide stain relief to the wire 96. In the embodiment shown, the second securing section 94 is crimped to the cover of the wire 96, however, other methods of termination may be used.

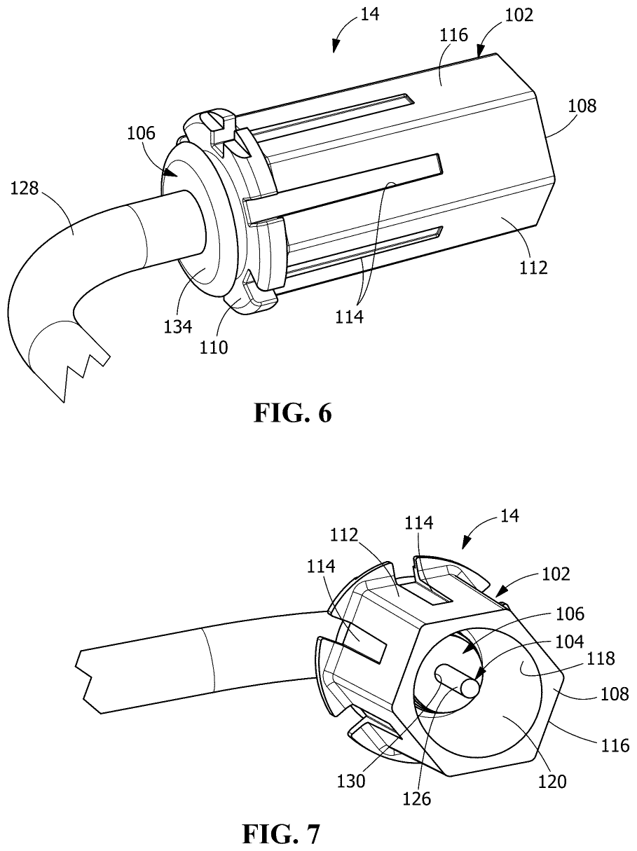

Referring to FIGS. 6 through 11, an illustrative embodiment of the plug connector assembly 14 is shown. The plug connector assembly 14 has a housing 102, an electrical terminal 104 and a compression/sealing member 106.

The housing 102 has a mating end 108 and an oppositely facing compression member receiving end 110. A side wall 112 extends between the mating end 108 and the compression member receiving end 110. Outer surfaces of the side wall 112 form a hexagonal configuration. However, other configurations may be used.

Latch receiving slots 114 are provided on the outside surface 116 of the side wall 112. The latch receiving slots 114 are configured to receive the latching portions 50 of the locking latches 46 when the receptacle connector assembly 12 and the plug connector assembly 14 are fully mated, as shown in FIG. 10.

Inside surface 118 of the side wall 112 forms a center terminal receiving opening 120. The inside surface 118 is tapered from mating end 108 to the compression member receiving end 110, whereby the terminal receiving opening 120 has a larger cross section proximate the mating end 108. A seal receiving opening 122 is positioned in the terminal receiving opening 120 proximate the compression member receiving end 110. The seal receiving opening 122 has ribs 124 which extend from the side walls into the opening 122, as shown in FIG. 10.

In the illustrative embodiment, the terminal 104 is a calrod with a mating portion 126 extending into the opening 120. In the embodiment shown, the mating portion 126 is a pin which is in electrical engagement with a wire 128.

The compression/sealing member 106 is made of a compressible material which can provide sealing from the exterior environment. Referring to FIGS. 7 and 10, the compression/sealing member 106 has an opening 130 through which the terminal 104 extends. The compression/sealing member 106 has a first section 132 which is positioned in the housing 102 and a second section 134 which is positioned outside of the housing 102. The first section 132 is dimensioned to have a diameter which is slightly larger than the diameter of the seal receiving opening 122, thereby allowing the first section 132 to be compressed when the first section 132 is inserted into the seal receiving opening 122. The first section 132 has ribs 136 provided about its circumference. The ribs 136 and the ribs 124 cooperate to enhance the seal between the first section 132 and the seal receiving opening 122. The second section 134 is positioned in engagement with the compression member receiving end 110 to also facilitate the seal between the housing 102 and the compression/sealing member 106. As the first section 132 is compressed in the seal receiving opening 122, the positioning of the mating portion 126 of the terminal 104 is also more precisely controlled.

When the receptacle connector assembly 12 and the plug connector assembly 14 are mated, the center terminal receiving member 60 of the housing 20 of the connector assembly 12 is moved into the center terminal receiving opening 120 of the housing 102 of the connector assembly 14. As this occurs, the side walls 44 and the locking latches 46 of the housing 20 are moved over the outside surface 116 of the side wall 112 of the housing 102. In the illustrative embodiment shown, the connector assembly 12 and the connector assembly 14 can be mated in six different orientations, as the housings 20, 102 have hexagonal configurations, as previously described.

As the connector assembly 12 and connector assembly 14 are moved to the fully mated position shown in FIGS. 9 and 10, the lead in surfaces 66 of the terminal receiving member 60 engaged the mating portion 126 of the terminal 104 to properly position and maintain the mating portion 126 of the terminal 104 in the terminal receiving opening 68 of the terminal receiving member 60. This ensures that the mating portion 126 of the terminal 104 will be properly aligned, and properly mate with the mating section 80 of the terminal 22. In addition, the ribs or projections 64 of the center terminal receiving member 60 engage the tapered inside surface 118 of the side walls 112 to ensure that the terminal receiving member 60 is properly positioned in the center terminal receiving opening 120.

As the connector assembly 12 and connector assembly 14 are moved to the fully mated position, the latching portions 50 of the locking latches 46 of the connector assembly 12 are moved along the outside surface 116 of the side wall 112 of the connector assembly 14, causing the locking latches 46 to be positioned in a stressed or resiliently deformed position. This continues until the connector assemblies are fully mated and the latching portions 50 are moved into the latch receiving slots 114, thereby allowing the locking latches 46 to return toward their unstressed position. With the latching portions 50 of the locking latches 46 positioned in the latch receiving slots 114, the assemblies are maintained in the mated position.

Referring to FIGS. 11 through 15, a second illustrative embodiment is shown. As shown The illustrative electrical connector assembly 210 includes an illustrative receptacle connector assembly 212 and an illustrative plug connector assembly 214. The receptacle connector assembly 212 may be mated to the plug connector assembly 214 in a number of various orientations, as will be more fully described.

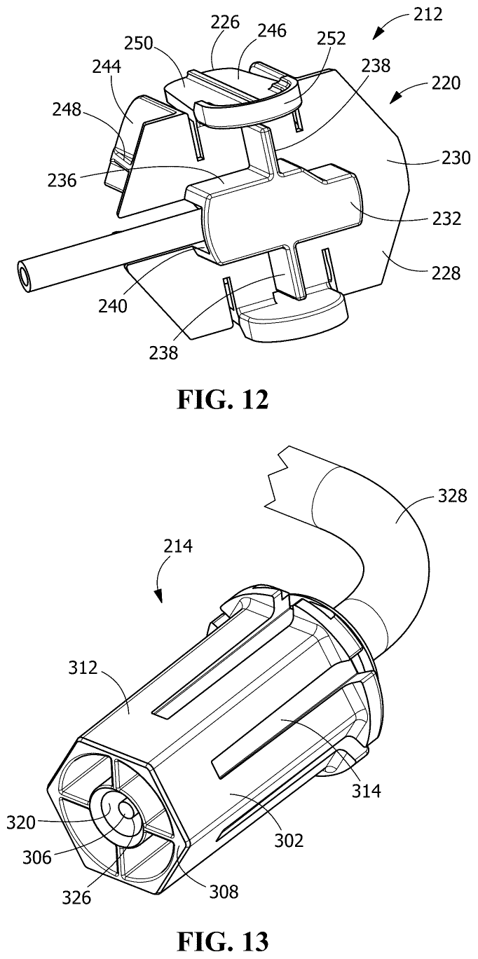

As shown in FIGS. 11 and 12, the illustrative receptacle connector assembly 12 includes a housing 220 and an electrical terminal 222. The housing 220 has a cold pin mating end 226 and an oppositely facing terminal receiving end 228.

As shown in FIG. 12, the terminal receiving end 228 of the housing 220 has a generally flat surface 230 which acts an a large ergonomic push surface to facilitate the mating of the receptacle connector assembly 212 to the plug connector assembly 214. A terminal cover portion 232 extends from the flat surface 230 in a direction away from the cold pin mating end 226. Latch limiting projections 238 extend from side surfaces 236 of the cover mounting portion 232. A terminal receiving recess 240 is provided in the cover portion 232. A terminal mounting opening 242 (FIG. 15) is provided in the terminal receiving recess 240.

Side walls 244 extend between the cold pin mating end 226 and the terminal receiving end 228. Releasable locking latches 246 also extend between the cold pin mating end 226 and the terminal receiving end 228. In the embodiment shown four side walls 244 and two locking latches 246 are provided to form a hexagonal configuration. However, other numbers and configurations of side walls 244 and locking latches 248 may be used.

The side walls 244 have supporting ribs or projections 248. The ribs or projections 248 extend from the side walls 244 to the underside of the flat surface 230 of the terminal receiving end 228 of the housing 220. The ribs or projections 248 provide structural integrity to the side walls 244.

The releasable locking latches 246 have latching portions 250 which extends from the terminal receiving end 228 toward the cold pin mating end 226. The releasable locking latches 46 have release portion 252 which extends from the terminal receiving end 228 in a direction away from the cold pin mating end 226. The releasable locking latches 246 are pivotally attached to the terminal receiving end 228, such that as the release portions 252 are moved toward the side surface 236, the latching portions 250 are moved outward. The side walls 244 and the locking latches 246 have angled lead in surfaces 254 provided proximate the cold pin mating end 226, as viewed in FIG. 11.

A center terminal receiving member 260 extends from the terminal receiving end 228 to the cold pin mating end 226. In the illustrative embodiment shown, the terminal receiving member 260 has a circular cross section with a continuous side wall 262.

The terminal receiving member 260 has a terminal receiving opening 268 which extends from the cold pin mating end 226 to the terminal receiving end 228. The terminal receiving opening 268 is positioned in alignment with the terminal mounting opening 242. A terminal positioning shoulder 270 is provided at the ends of the terminal receiving opening 268 proximate the cold pin mating end 226.

The illustrative terminal 222 is essentially the same as terminal 22, the description of which is incorporated herein by reference. The terminal 222 has a mating section 280 and a wire receiving section 282. In the illustrative embodiment shown, an longitudinal axis of the mating section 280 is positioned approximately at ninety degrees to a longitudinal axis of the wire receiving section 282.

Referring to FIGS. 13 through 15, an illustrative embodiment of the plug connector assembly 214 is shown. The plug connector assembly 214 has a housing 302, an electrical terminal 304 and a compression/sealing member 306.

The housing 302 has a mating end 308 and an oppositely facing compression member receiving end 310. A side wall 312 extends between the mating end 308 and the compression member receiving end 310. Outer surfaces of the side wall 312 form a hexagonal configuration. However, other configurations may be used.

Latch receiving slots 314 are provided on the outside surface 316 of the side wall 312. The latch receiving slots 314 are configured to receive the latching portions 250 of the locking latches 246 when the receptacle connector assembly 212 and the plug connector assembly 214 are fully mated, as shown in FIG. 15.

A center opening 320 is provided in the housing 302 and extends from the mating end 308 to the compression member receiving end 310. The opening 320 has a terminal receiving portion 321 and seal receiving portion 322. A cross sectional diameter of the terminal receiving portion 321 is smaller than s cross sectional diameter of the seal receiving portion 322. Positioning projections or ribs 323 extend from the side wall 312 into the terminal receiving portion 321 of the center opening 320. The positioning projections or ribs 323 are configured to engage the terminal 322, to properly position and maintain the terminal 322 in the center of the terminal receiving portion 321 of the center opening 320.

The seal receiving portion 322 is positioned proximate the compression member receiving end 310. The seal receiving opening 322 has ribs 324 which extend from the side walls into the seal receiving portion 322, as shown in FIG. 15.

In the illustrative embodiment, the terminal 304 is a calrod with a mating portion 326 extending into the terminal receiving portion 321 of the center opening 320. In the embodiment shown, the mating portion 326 is a pin which is in electrical engagement with a wire 328.

The compression/sealing member 306 is made of a compressible material which can provide sealing from the exterior environment. The compression/sealing member 306 has an opening 330 through which the terminal 304 extends. The compression/sealing member 306 has a first section 332 which is positioned in the housing 302 and a second section 334 which is positioned outside of the housing 302. The first section 332 is dimensioned to have a diameter which is slightly larger than the diameter of the seal receiving portion 322, thereby allowing the first section 332 to be compressed when the first section 332 is inserted into the seal receiving portion 322. The first section 332 has ribs 336 provided about its circumference. The ribs 336 and the ribs 324 cooperate to enhance the seal between the first section 332 and the seal receiving portion 322. The second section 334 is positioned in engagement with the compression member receiving end 310 to also facilitate the seal between the housing 302 and the compression/sealing member 306. As the first section 332 is compressed in the seal receiving portion 322, the positioning of the mating portion 326 of the terminal 304 is also more precisely controlled.

When the receptacle connector assembly 212 and the plug connector assembly 214 are mated, the center terminal receiving member 260 of the housing 220 of the connector assembly 212 is moved into the center terminal receiving opening 320 of the housing 302 of the connector assembly 214. As this occurs, the side walls 244 and the locking latches 246 of the housing 120 are moved over the outside surface 316 of the side wall 312 of the housing 302. In the illustrative embodiment shown, the connector assembly 212 and the connector assembly 214 can be mated in six different orientations, as the housings 220, 302 have hexagonal configurations, as previously described.

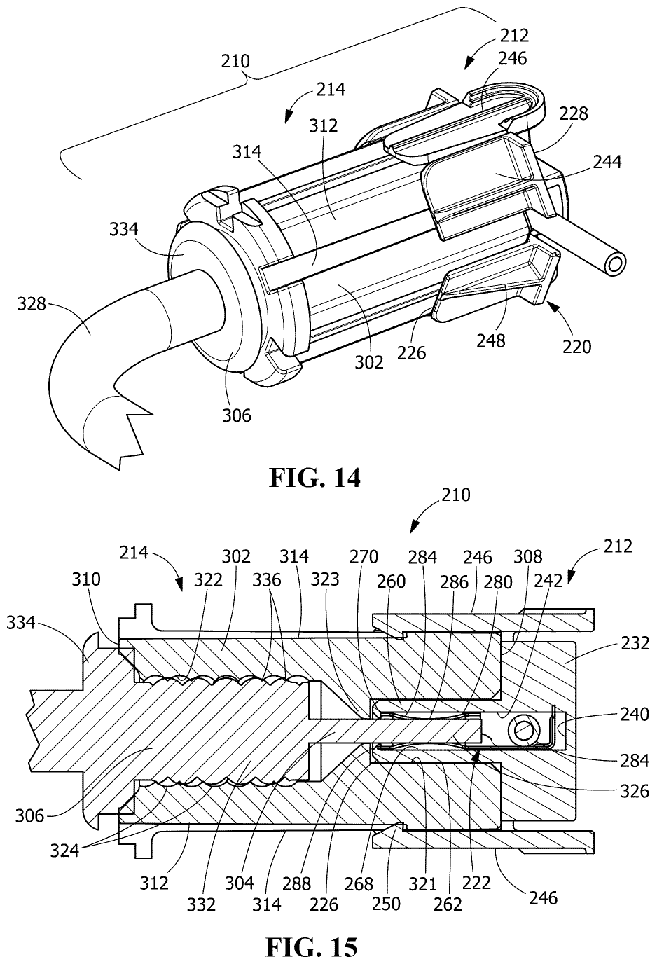

As the connector assembly 12 and connector assembly 14 are moved to the fully mated position shown in FIGS. 14 and 15, the mating portion 326 of the terminal 304 is held in proper position in the terminal receiving opening 320 by the projections or ribs 323 and the mating section 280 of the terminal 222 is held in proper position by the walls of the terminal receiving member 260. This ensures that the mating portion 326 of the terminal 304 will be properly aligned, and properly mate with the mating section 280 of the terminal 222.

As the connector assembly 212 and connector assembly 214 are moved to the fully mated position, the latching portions 250 of the locking latches 246 of the connector assembly 212 are moved along the outside surface 316 of the side wall 312 of the connector assembly 214, causing the locking latches 246 to be positioned in a stressed or resiliently deformed position. This continues until the connector assemblies are fully mated and the latching portions 250 are moved into the latch receiving slots 314, thereby allowing the locking latches 246 to return toward their unstressed position. With the latching portions 250 of the locking latches 246 positioned in the latch receiving slots 314, the assemblies are maintained in the mated position.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. An electrical connector comprising:
a housing having a mating end and a terminal receiving end;
housing side walls and housing releasable locking latches extending between the mating end and the terminal receiving end;
a center terminal receiving member extending from the terminal receiving end to the mating end;
a terminal positioned in the center terminal receiving member, the terminal having a mating section and a wire receiving section;
wherein the connector can be mated at different orientations relative to a mating electrical connector.

2. The electrical connector as recited in claim 1, wherein the terminal receiving end of the housing has a generally flat surface which acts an a large ergonomic push surface to facilitate the mating of the connector to the mating electrical connector.

3. The electrical connector as recited in claim 2, wherein a cover mounting portion extends from the flat surface in a direction away from the mating end, the cover mounting portion has latching projections and latch limiting projections.

4. The electrical connector as recited in claim 3, a terminal receiving recess is provided in the cover mounting portion and extends from the flat surface in a direction toward the mating end.

5. The electrical connector as recited in claim 4, wherein the housing has a cover provided at the terminal receiving end.

6. The electrical connector as recited in claim 1, wherein the housing side walls and the housing releasable locking latches are configured in a hexagonal configuration.

7. The electrical connector as recited in claim 2, wherein the side walls have supporting ribs or projections which extend from the side walls to an underside of the flat surface of the terminal receiving end of the housing.

8. The electrical connector as recited in claim 1, wherein the releasable locking latches have latching portions which extend from the terminal receiving end toward the mating end, the releasable locking latches have release portions which extends from the terminal receiving end in a direction away from the mating end, the releasable locking latches are pivotally attached to the terminal receiving end.

9. The electrical connector as recited in claim 1, wherein the terminal receiving member has a circular cross section with a continuous side wall.

10. The electrical connector as recited in claim 9, wherein projections extend outward from the side wall of the terminal receiving member toward the housing side walls and the housing locking latches. The ribs or projections 64 are spaced periodically around the circumference of the side wall.

11. The electrical connector as recited in claim 9, wherein the side wall of the terminal receiving member has a sloped lead in surface proximate the mating end.

12. The electrical connector as recited in claim 11, wherein the terminal receiving member has a terminal receiving opening which extends from the lead in surface to the terminal receiving end.

13. The electrical connector as recited in claim 1, wherein a longitudinal axis of the mating section is positioned approximately at ninety degrees to a longitudinal axis of the wire receiving section.

14. The electrical connector as recited in claim 13, wherein the mating section has a cylindrical configuration with multiple resilient contact beams which have contact sections which extend inward.

15. An electrical connector assembly comprising:
a first electrical connector comprising:
a first housing having a first mating end and a first terminal receiving end;
first housing side walls and first housing releasable locking latches extending between the first mating end and the first terminal receiving end;
a first center terminal receiving member extending from the first terminal receiving end to the first mating end;
a first terminal positioned in the first center terminal receiving member, the first terminal having a first mating section and a first wire receiving section;
a second electrical connector comprising:
a second housing having a second mating end and a second compression member receiving end;
second housing side walls extending between the second mating end and the second compression member receiving end;
a second terminal receiving opening extending from the second mating end;
a second terminal positioned in the second terminal receiving opening;
a compression member provided in the second terminal receiving opening proximate the second compression member receiving end;
wherein the first electrical connector can be mated at different orientations relative to the second electrical connector.

16. The electrical connector assembly as recited in claim 15, wherein the first housing side walls and the first housing releasable locking latches are configured in a defined configuration, and the second housing side walls are configured in a similar defined configuration.

17. The electrical connector assembly as recited in claim 15, wherein walls of the second center terminal receiving opening are tapered from mating end to the compression member receiving end, whereby the second center terminal receiving opening has a larger cross section proximate the mating end.

18. The electrical connector assembly as recited in claim 17, wherein a compression member receiving opening is positioned in the second center terminal receiving opening proximate the compression member receiving end.

19. The electrical connector assembly as recited in claim 15, wherein the second center terminal receiving opening extends from the mating end to the compression member receiving end, the second center terminal receiving opening has a terminal receiving portion and seal receiving portion, a cross sectional diameter of the terminal receiving portion is smaller than s cross sectional diameter of the seal receiving portion, positioning projections extend from a side wall of the second center terminal receiving opening into the terminal receiving portion of the center opening, the positioning projections engage the second terminal, to properly position and maintain the second terminal in a center of the terminal receiving portion of the second center terminal receiving opening.

20. The electrical connector assembly as recited in claim 19, wherein the seal receiving portion is positioned proximate the compression member receiving end, the seal receiving opening has ribs which extend from the side walls into the seal receiving portion, the compression member extending from the seal receiving portion.
